(19) United States
(12) Patent Application Publication
(10) Pub. No.: US 2026/0244814 A1
(43) Pub. Date: Aug. 20, 2026

(54) AUGMENTING DESIGN VARIABLE DATA

(71) Applicant: ROLLS-ROYCE PLC, London (GB)

(72) Inventors: Petru-Cristian CIMPOESU, Southampton (GB); David J J TOAL, Southampton (GB); Leran WANG, Southampton (GB); Andrew J KEANE, Southampton (GB); Frederic WITHAM, Derby (GB)

(73) Assignee: ROLLS-ROYCE PLC, London (GB)

(21) Appl. No.: 19/535,141

(22) Filed: Feb. 10, 2026

(30) Foreign Application Priority Data
Feb. 14, 2025 (GB) 2502180.9

(51) Int. Cl. G06F 30/17; G06F 17/18; G06F 30/15; G06F 30/367

(52) U.S. Cl. CPC G06F 30/17; G06F 17/18; G06F 30/15; G06F 30/367

(57) ABSTRACT

Augmenting design variable data associated with a new parameterisation. A first and second set of physical quantities are obtained that are sampled from one or more simulations associated with a source and target parameterisation, defining source and target points in a physics space, for which a distribution is determined. A first set of design variables in terms of the target parameterisation is obtained corresponding to the simulations associated with the target parameterisation, and which define target points in a design variable space. A second set of design variables in terms of the target parameterisation is generated by evaluating source points in design variable space which exist on or within a boundary of the same hypersurface as the target points, and which minimise the difference between the distribution of source points and target points in physics space and the distribution of source and target points in design variable space.

### CROSS-REFERENCE TO RELATED APPLICATIONS

This application claims priority to United Kingdom Patent Application No 2502180.9 filed Feb. 14, 2025, the whole contents of which are incorporated herein by reference in their entirety.

### FIELD

This disclosure relates to augmenting design variable data associated with a new parameterisation.

### BACKGROUND

Surrogate models are used in engineering to reduce the computational complexity associated with evaluating a new design. For example, a surrogate model with a small number of input parameters may be used in lieu of high-fidelity computations such as computational fluid dynamics (CFD) simulations. The model may be conceptualised as a black box which, within an understood margin of error, emulates such simulations.

Expressed another way, a model f may act as a surrogate representation of the physical process used to determine some objective f whose computation is prohibitively expensive and leads to a limited number of training samples X.

### SUMMARY

In a first aspect, there is provided a computer-implemented method of augmenting design variable data associated with a new parameterisation, comprising:
obtaining a first set of physical quantities sampled from one or more simulations associated with a source parameterisation, the first set of physical quantities defining source points in a physics space;
obtaining a second set of physical quantities sampled from one or more simulations associated with a target parameterisation, the second set of physical quantities defining target points in physics space;
determining a distribution of the source points and the target points in physics space;
obtaining a first set of design variables in terms of the target parameterisation and which correspond with the simulations associated with the target parameterisation, the first set of design variables defining target points in a design variable space; and
generating a second set of design variables in terms of the target parameterisation by evaluating source points in design variable space which exist on or within a boundary of the same hypersurface as the target points in design variable space, and which minimise the difference between the distribution of source points and target points in physics space and the distribution of source points and target points in design variable space.

In an embodiment, the first set of physical quantities and the second set of physical quantities are combined to form a physics data structure defining source and target points in a design variable space.

In an embodiment, the physics data structure is a matrix of dimension (n+m)×d, where m is a number of sampled simulations associated with a source parameterisation, n is a number of sampled simulations associated with a target parameterisation, and d is a number of physical quantities sampled from each simulation.

In an embodiment, determination of the distribution of the source and target points in physics space comprises normalising the first set of physical quantities and the second set of physical quantities to have zero mean and unit standard deviation.

In an embodiment, determination of the distribution of the source and target points in physics space comprises evaluating pairwise similarity over the source points and the target points in physics space, whereby the resulting co-variance is a first probability density function.

In an embodiment, evaluation of the pairwise similarity over the source points and the target points in physics space uses a Gaussian kernel function normalised by a softmax function.

In an embodiment, determination of the distribution of the source and target points in design variable space comprises evaluating pairwise similarity over the source points and the target points in design variable space, whereby the resulting co-variance is a second probability density function.

In an embodiment, evaluation of the pairwise similarity over the source points and the target points in design variable space uses a Cauchy distribution.

In an embodiment, the second set of design variables are generated using an iterative process.

In an embodiment, the iterative process comprises a vectorised gradient calculation that minimises a loss function that expresses differences between the first distribution and the second distribution.

In an embodiment, the method further comprises repeating one or more of:
evaluating pairwise similarity over the source points and the target points in physics space, and
evaluating pairwise similarity over the source points and the target points in design variable space;
a plurality of times using different parameters to maximise a mean accuracy metric.

In an embodiment, the physical quantities sampled from the first set of simulations and the second set of simulations are downsampled according to the same sampling strategy.

In an embodiment, the downsampling comprises interpolation between simulation output and a set of fixed points.

In an embodiment, the set of fixed points are a constant grid.

In an embodiment, the method further comprises training a new surrogate model in terms of the target parameterisation using the first set of design variables, the second set of design variables, the first set of physical quantities and the second set of physical quantities.

In an embodiment, the target parameterisation is different from the source parameterisation.

In an embodiment, the one or more simulations comprise the output of a computational fluid dynamics or a finite element analysis simulation.

In an embodiment, the one or more simulations relate to simulation of a gas turbine engine or a gas turbine engine component.

In a second aspect, there is provided a computer-readable medium comprising instructions executable by a computer which, when executed, cause the computer to perform the aforesaid method.

In a third aspect, there is provided apparatus for augmenting design variable data associated with a new parameterisation, comprising memory and a processor configured to:
obtain, from said memory, a first set of physical quantities sampled from one or more simulations associated with a source parameterisation, the first set of physical quantities defining source points in a physics space;
obtain, from said memory, a second set of physical quantities sampled from one or more simulations associated with a target parameterisation, the second set of physical quantities defining target points in physics space;
determine a distribution of the source points and the target points in physics space;
obtain, from said memory, a first set of design variables in terms of the target parameterisation and which correspond with the simulations associated with the target parameterisation, the first set of design variables defining target points in a design variable space; and
generate a second set of design variables in terms of the target parameterisation by evaluating source points in design variable space which exist on or within a boundary of the same hypersurface as the target points in design variable space, and which minimise the difference between the distribution of source points and target points in physics space and the distribution of source points and target points in design variable space.

### BRIEF DESCRIPTION OF THE DRAWINGS

Embodiments will now be described by way of example only with reference to the accompanying drawings, in which:

FIG. 1 shows a knowledge transfer framework for augmenting design variable data;

FIG. 2 shows a data augmentation system forming part of the framework of FIG. 1;

FIG. 3 shows processes carried out by the data augmentation system of FIG. 2;

FIG. 4 shows an example design for a gas turbine combustor to which the knowledge transfer framework was applied;

FIG. 5 shows an example of simulation output for a sector of the combustor of FIG. 4; and

FIG. 6 shows a comparison of performance of the knowledge transfer framework of FIG. 1 against an existing approach.

### DETAILED DESCRIPTION

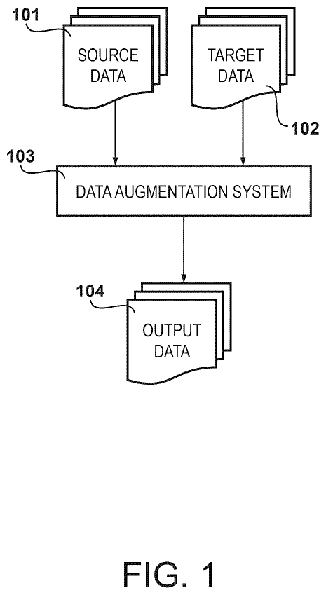

A knowledge transfer framework for augmenting design variable data is shown in FIG. 1.

In this framework, source data 101 and target data 102 are available which, respectively, relate to a historic task and to a new task which each relate some design variables to an objective. The source data 101 comprises a set of historical design variable data {Xₕᵢₛₜ, yₕᵢₛₜ} each element of which has an associated historical simulation. Similarly, the target data 102 comprises a set of new design variable data {X_{new}, y_{new}} each element of which has an associated new simulation. In both cases, the physical quantities in the simulations comprised in the source data 101 and target data 102 are closely related to the dependent variables yₕᵢₛₜ and y_{new}.

The two tasks to which source data 101 and target data 102 relate are associated inasmuch as their objective functions obey the same laws of physics, for example they may relate to a computational fluid dynamics problem or a finite element analysis problem. In the context of the present knowledge transfer framework, however, the design variable parameterisation of the tasks may differ. One example application of this is in the design process of gas turbine engines, where computational fluid dynamics may be used to predict fluid flows within the engine, and finite element analysis may be used to assess mechanical integrity. A typical situation is that source data 101 may exist for a historic product design and development program in the form of a legacy parameterisation, but a new program intendeds to utilise a new parameterisation.

A data augmentation system 103 receives the source data 101 and target data 102 and produces output data 104 which may be used to train a new surrogate model.

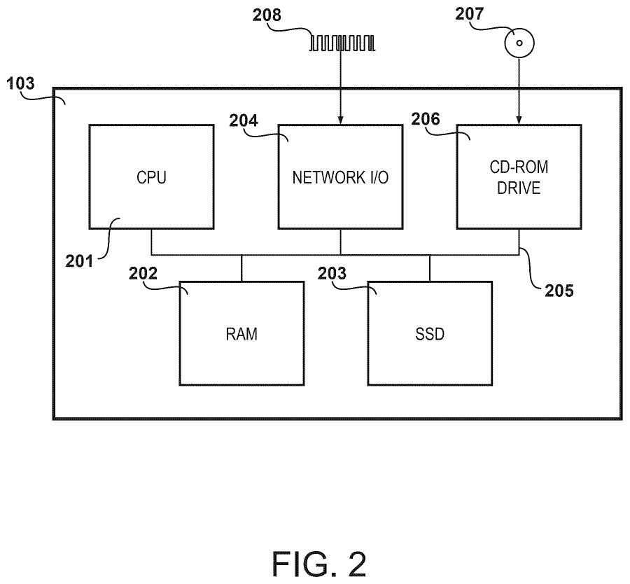

The data augmentation system 103 is shown in more detail in FIG. 2.

The data augmentation system 103 comprises a processor which in the present embodiment is a central processing unit (CPU) 201. In this instance, central processing unit 201 is a single Intel® Core i7 processor, having eight on-die processing cores operating at 4.0 gigahertz. It is of course possible that other processor configurations could be provided, and indeed several such processors could be present to provide a high degree of parallelism in the execution of instructions.

Over and above registers and cache in the CPU 201, memory is provided for by random access memory (RAM) 202, which in this example is double data rate (DDR) SDRAM totaling 32 gigabytes in capacity. RAM 202 allows storage of frequently used instructions and data structures by the data augmentation system 103. A portion of RAM 202 is reserved as shared memory, which allows high speed inter-process communication.

Permanent storage is provided by a storage device such a solid-state disk (SSD) 203, which in this instance has a capacity of 512 gigabytes. SSD 203 stores operating system, application data and may also provide virtual memory for the data augmentation system 103. In alternative embodiments, a hard disk drive could be provided, or several storage devices provided and configured as a RAID array to improve data access times and/or redundancy.

Together, the registers and cache in CPU 201, the RAM 202 and the SSD 203 provide “memory” for the data augmentation system 103 and it will be appreciated that at any one moment data could be stored in any of these locations.

A network interface 204 allows the data augmentation system 103 to connect to a packet-based network such as the Internet.

The CPU 201, RAM 202, solid-state disk 203, network interface 204 are all connected with a bus 205 to facilitate communication and transfer of data.

An optical drive, such as a CD-ROM drive 206 is also connected to the bus 205, and may receive a non-transitory computer readable medium such as an optical disk, for example CD-ROM 207. The CD-ROM 207 comprises computer-readable instructions to enable the data augmentation process to be executed. These are, in use, installed on solid-state disk 203, loaded into RAM 202 and then executed by CPU 201. Alternatively, these instructions may be downloaded from a network via the network interface 204 as packet data 208.

It will be appreciated that the above system is merely an example of a configuration of system that can fulfil the role of the data augmentation system 103. Any other system having a processing device and memory could be used. Thus, in an alternative embodiment it is envisaged that an application-specific integrated circuit (ASIC) or field-programmable gate array (FPGA) could be configured with the same instructions so as to perform substantially the same operations as the data augmentation system 103.

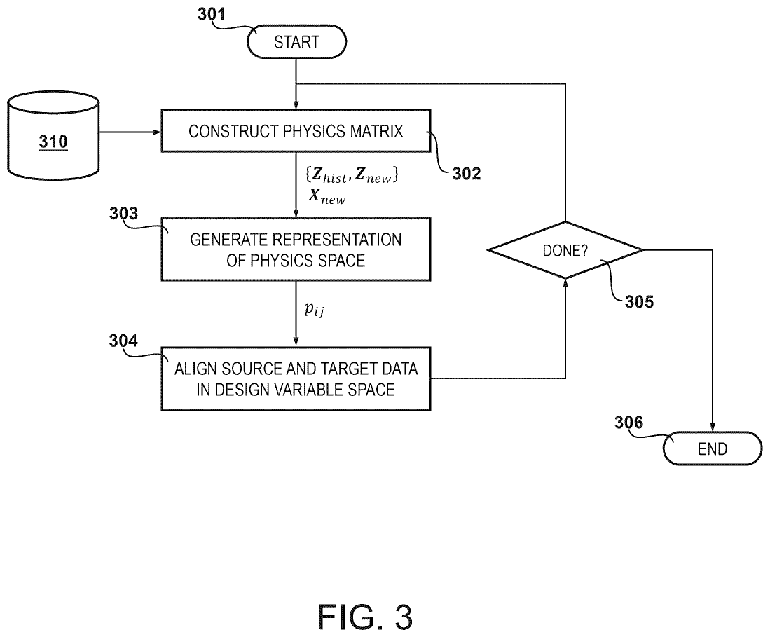

Processes carried out by the data augmentation system 103 are shown in FIG. 3. In the present embodiment, an iterative approach is used to perform the process of augmenting design variable data using a number of hyperparameters. The output is then the best result of w iterations.

The process starts at step 301 and at step 302, the vth iteration's hyperparameters are set. In the present embodiment the hyperparameters are perplexity p and weight factor α. Then, a set of d physical quantities are sampled from the simulations comprised in the source data 101 and target data 102. (The source data 101 and target data 102 may either be stored locally, either in RAM 202 or on SSD 203, or may be obtained from a networked storage device accessed via the network interface 204—in the present example a generic datastore 310 is shown.) This results in the creation of two physics matrices in memory: a historic physics matrix

$${Z}_{h i s t}^{m \times d}$$

which has a one-to-one correspondence with the entries of some historical set of variables Xₕᵢₛₜ and a new physics matrix

$${Z}_{n e w}^{n \times d}$$

which has a one-to-one correspondence with the entries of X_{new}. It will be appreciated that this process encodes the sampled physical quantities within a manifold in a physics space. More particularly, the sampled physical quantities in the physics matrices Z_{new},Zₕᵢₛₜ are, respectively, new and historic points on or within the boundary of a hypersurface in a physics space.

In the present embodiment, the physics matrices Z_{new},Zₕᵢₛₜ are normalised by the processor 201 so as to have zero mean and unit standard deviation. This means that the historic and new sampled physical quantities are stored on or within the boundary of a unit hypercube in the physics space.

The physics matrices Z_{new},Zₕᵢₛₜ created in step 302 are supplied to step 303 along with X_{new}, which is the independent variables of the target training set. It will be noted on inspection of the process illustrated in FIG. 3 that Xₕᵢₛₜ is not required. In other words, the procedure allows the reuse of historical data regardless of the parameterisation of the historical problem.

The objective of step 303 is to compress the columns of Zₕᵢₛₜ such that the reduced set of variables associated therewith matches the independent variables of X_{new}.

Firstly, the new and historical physical quantities are concatenated by the processor 201 into a physics data structure in memory. In the present embodiment this is a matrix Ż={Z_{new},Zₕᵢₛₜ} which has dimension (n+m)×d.

Then, a Gaussian kernel is built to represent pairwise distances between the rows of Ż as follows:

$${p}_{i \vert j} = \frac{exp ( - {d ( {z}_{i} , {z}_{j} )}^{2} / ( 2 {σ}_{i}^{2} ) )}{{\sum }_{k \neq i} exp ( - {d ( {z}_{i} , {z}_{k} )}^{2} / ( 2 {σ}_{i}^{2} ) )} \qquad [ Equation 1 ]$$

$${p}_{i \vert i} = 0$$

In the present embodiment, the distance d(zᵢ,zⱼ)² is the squared Euclidean. It will be appreciated that other distance functions could be used.

The standard deviations of are indirectly controlled by the perplexity hyperparameter, p. Perplexity controls whether local or global compression fidelity is prioritised. A lower value ensures that local patterns are more accurately represented post-compression, whereas a higher value prioritises the accuracy of the global representation. Hence, in the present embodiment, the perplexity is varied over the iterations. In the present embodiment, a grid search is used for this iterative process. Alternatively, the perplexity could be varied manually or using a different algorithm.

The terms of the Gaussian probability may then be expressed as:

$$( \begin{matrix}{p}_{H \vert N} & {p}_{N \vert N} \\ {p}_{H \vert N} & {p}_{N \vert N}\end{matrix} ) \qquad [ Equation 2 ]$$

where the subscripts N, H in Equation 2 refer to new and historical data, respectively.

There are two things to note about Equation 2. First, the matrices p_{N|H} and p_{H|N} are not square. Second, the two conditional probabilities are incompatible or, in other words, a given probability p_{H|N} is not necessarily equal to p_{N|H}. To deal with this, a fuzzy union based on the t-conorm is evaluated which represents a union of the probabilities p_{N|H},p_{H|N} and which is defined as:

$${P}_{NH} = {P}_{N \vert H} + {( {p}_{H \vert N} )}^{T} - {p}_{N \vert H} ∘ {( {p}_{H \vert N} )}^{T} \qquad [ Equation 3 ]$$

where ∘ is the pointwise product. There is no need to apply this operation to the p_{H|H} terms.

In the present embodiment, the softmax function is then applied to the probabilities p_{NH} and p_{HH} obtain a probability density function:

$${p}_{i j} = \frac{{p}_{N H}}{{\sum }_{i} {\sum }_{j} {p}_{N H}} \qquad [ Equation 4 ]$$

The probability matrix pᵢⱼ represents the distribution between historical and new tasks in physics space.

The objective of the next phase of the process at step 304 is to align the source and target data in design variable space. In other words, the physics matrix Ż is compressed to the design variables of X_{new}. This compression is possible because the target dataset X_{new} already fulfils this constraint and has a one-to-one correspondence with the terms Z_{new} of Ż. Hence step 303 comprises fixing X_{new} and finding a set of points X that preserves the distances associated with Zₕᵢₛₜ. It will therefore also be appreciated that the terms p_{N|N} are no longer required as their corresponding X_{new} points are fixed.

To find the points \hat{X}, a random initialisation is performed, followed by an optimisation loop. The objective is to minimise the Kullback-Leibler (KL) divergence between the remaining terms of the Gaussian distribution and a custom Student t-distribution.

The probability density function for the design variable space is obtained in a similar manner. In the present embodiment, the Cauchy distribution is used. The probability density functions are defined as:

$${q}_{ij}^{NH} = \frac{{( 1 - {‖ {x}_{i} - {\hat{x}}_{j} ‖}^{2} )}^{- 1}}{{\sum }_{k} {\sum }_{k \neq l} {( 1 - {‖ {x}_{k} - {\hat{x}}_{l} ‖}^{2} )}^{- 1}} \qquad [ Equation 5 ]$$

$${q}_{ij}^{HH} = \frac{{( 1 - {‖ {\hat{x}}_{i} - {\hat{x}}_{j} ‖}^{2} )}^{- 1}}{{\sum }_{k} {\sum }_{k \neq l} {( 1 - {‖ {\hat{x}}_{k} - {\hat{x}}_{l} ‖}^{2} )}^{- 1}}$$

The optimisation problem is thus to find locations associated with the historical task, \hat{X} such that the distributions pᵢⱼ and qᵢⱼ are as similar as possible. The terms X_{new}, associated with the new task, are fixed. The loss function for this problem is the KL divergence, defined as:

$$K L ( P ‖ Q ) = α {\sum }_{j} {\sum }_{i \neq j} {p}_{NH}^{ij} log \frac{{p}_{NH}^{ij}}{{q}_{NH}^{i j}} + ( 1 - α ) {\sum }_{j} {\sum }_{i \neq j} {p}_{HH}^{ij} log \frac{{p}_{HH}^{ij}}{{q}_{HH}^{ij}} \qquad [ Equation 6 ]$$

The two terms of the loss function are differences between the distribution of points in the physics matrix and the distribution of points in the augmented training data matrix \dot{X}={X_{new},\hat{X}}. The first term represents differences between new and historical samples, as denoted by the subscript NH. The second term is used to ensure that the structure of the historical data \hat{X} matches the structure of Zₕᵢₛₜ. The term α controls the trade-off between the two and is necessary to ensure that the contributions to the loss function corresponding to the first term are not drowned out by those of the second term, which will usually have a much larger volume of data. In the present embodiment, a vectorised gradient formulation is used for updates. This is defined as:

$$\frac{1}{4} \frac{\partial K L}{\partial \hat{X}} = α ( \hat{X} ∘ K \vec{1} - K {X}_{n e w} ) + ( 1 - α ) ( D - \tilde{K} ) \hat{X} \qquad [ Equation 7 ]$$

$$where$$

$$K = ( \begin{matrix}\frac{{p}_{11}^{NH} - {q}_{11}^{NH}}{1 + ‖ {\hat{x}}_{1} - {x}_{1} {‖}^{2}} & … & \frac{{p}_{1 n}^{NH} - {q}_{1 n}^{NH}}{1 + ‖ {\hat{x}}_{1}^{h i s t} - {x}_{n} {‖}^{2}} \\ ⋮ & ⋱ & ⋮ \\ \frac{{p}_{m 1}^{N H} - {q}_{m 1}^{N H}}{1 + {‖ {\hat{x}}_{m} - {x}_{1} ‖}^{2}} & … & \frac{{p}_{m n}^{N H} - {q}_{m n}^{N H}}{1 + {‖ {\hat{x}}_{m} - {x}_{n} ‖}^{2}}\end{matrix} ) \qquad [ Equation 8 ]$$

$$\tilde{K} = ( \begin{matrix}\frac{{p}_{11}^{NH} - {q}_{11}^{HH}}{1 + {‖ {\hat{x}}_{1} - {\hat{x}}_{1} ‖}^{2}} & … & \frac{{p}_{1 m}^{HH} - {q}_{1 m}^{HH}}{1 + {‖ {\hat{x}}_{1} - {\hat{x}}_{m} ‖}^{2}} \\ ⋮ & ⋱ & ⋮ \\ \frac{{p}_{m 1}^{HH} - {q}_{m 1}^{HH} :}{1 + {‖ {\hat{x}}_{m} - {\hat{x}}_{1} ‖}^{2}} & … & \frac{{p}_{m m}^{HH} - {q}_{m m}^{HH}}{1 + {‖ {\hat{x}}_{m} - {\hat{x}}_{m} ‖}^{2}}\end{matrix} ) \qquad [ Equation 9 ]$$

$$D = ( \begin{matrix}\vec{1} {\tilde{K}}_{1 m} & & \\ & ⋱ & \\ & & \vec{1} {\tilde{K}}_{mm}\end{matrix} ) \qquad [ Equation 10 ]$$

After evaluating \hat{X} and storing it in memory, in the present embodiment a question is asked at step 305 as to whether all w iterations have been done. If not, then control returns to step 302 where the next iteration v+1 is performed with different variables. Eventually, all w iterations will be complete and control will proceed to step 306 where the process ends, with the best candidate for X then being able to be selected.

To further aid understanding of the principles disclosed herein, a specific implementation is now presented in pseudocode.

Algorithm 1

```
The following algorithm returns the optimal embedding:
  1: function GETOPTIMALEMBEDDING (X_{new}, Z_{new}, Zₕᵢₛₜ)
  2: perplexities = {1, 2, 4, 8, 16, 32, 64, 128}
  3: fractions = {0:10} × 0.1
  4: p, f = MeshGrid(perplexities, fractions)
  5: p, f = Flatten(p), Flatten(f)
  6: best_acc = 0
  7: for all pᵢ, fᵢ ∈ p, f do
  8: input_structure ← TsneSetup(X_{new}, Z_{new}, Zₕᵢₛₜ, pᵢ)
  9: \hat{X} ← TsneOpt(input_structure, fᵢ)
10:  $X ← [ \begin{matrix}{X}_{new} \\ \hat{X}\end{matrix} ]$
11:  $Z ← [ \begin{matrix}{Z}_{new} \\ {Z}_{hist}\end{matrix} ]$
12: mam ← mean_accuracy_metric(X, Z)
13: if mam > best_acc then
14: best_acc ← mam
15: \hat{X}_{best} ← \hat{X}
16: end if
17: end for
18: return \hat{X}_{best}
19: end function
```

Algorithm 2

```
The following algorithm builds the probability distribution:
  1: function TSNESETUP (X_{new}, Z_{new}, Zₕᵢₛₜ, perplexity)
  2: Initialise y using [symbol] (0,1) × 10-4
  3:  ${X}_{new} ← \frac{{X}_{new} - μ}{σ}$
  4:  ${Z}_{n e w} ← \frac{{Z}_{new} - μ}{σ}$
  5:  ${Z}_{h i s t} ← \frac{{Z}_{h i s t} - μ}{σ}$
  6:  $Z ← [ \begin{matrix}{Z}_{nist} \\ {Z}_{new}\end{matrix} ]$
  7: DistMat ← PairwiseDistance(Z, Z, distance)
  8: P ← Search Var(DistMat, perplexity)
  9: Nₕᵢₛₜ ← nrows(Zₕᵢₛₜ)
10: P_{H|N} ← P[1:Nₕᵢₛₜ, Nₕᵢₛₜ + 1:end]
11: P_{N|H} ← P[Nₕᵢₛₜ + 1:end, 1:Nₕᵢₛₜ]
12:  ${p}_{N H} ← softmax ( {P}_{H \vert N} + {p}_{N \vert H}^{T} - {p}_{H \vert N} ∘ {p}_{N \vert H}^{T} )$
13: P_{HH} ← softmax(P[1:Nₕᵢₛₜ, 1:Nₕᵢₛₜ])
14: OutputDictionary ← {ystart, X_{new}, P_{NH}, P_{HH}, μ_{X}_{_{new}}, σ_{X}_{_{new}})
15: return OutputDictionary
16: end function
```

Algorithm 3
The following algorithm computes the standard deviations, σ:

| | |
|---|---|
| 1: | function SEARCHVAR(p, perplexity) |
| 2: | Binary search for σᵢ over rows i of p such that perplexity = 2^{H(i)}, where H(i) = |
| | − Σⱼ p_{j\|i} log₂ (p_{j\|i}) |
| 3: | end function |

Algorithm 4
The following algorithm optimises the embedding:

| | |
|---|---|
| 1: | function TSNEOPT(input_structure, fraction) |
| 2: | Any optimisation scheme which takes loss or gradients as arguments |
| 3: | grad, loss = ModTsneGrad(p_{NH}, X_{new}, \textcircled{X}, p_{HH}, fraction) |
| 4: | end function |

Algorithm 5

```
The following algorithm performs a vectorised computation of loss and
gradients of embedding:
  1: function MODTSNEGRAD(ProbMatX, X_{new}, \hat{X}, pⱼⱼ, frac)
  2: N ← nrows(\hat{X})
  3:  ${numeratorProbMatY}^{′} ← \frac{1}{( 1 + SquaredEuclidianDistance ( \hat{X} , \hat{X} ) )}$
  4: numeratorProbMatY′ [1:N + 1:end] ← 0
  5:  ${ProbMatY}^{′} ← \frac{{numeratorProbMatY}^{′}}{\sum ( Flatten ( {numeratorProbMatY}^{′} ) )}$
  6: \tilde{K} = numerator ProbMatY′ ○ (pⱼⱼ - ProbMatY′)
  7: Grad₁ ← 4 * (diag(E_{rows} \tilde{K}) − \tilde{K})
  8: entropy'_{X} = Flatten(ProbMatX)^{T} × log(Flatten(ProbMatX))
  9: entropy'_{Y} = Flatten(ProbMatY')^{T} × log(Flatten(ProbMatY'))
10: KL'_{DIV} = entropy'_{X} − entropy'_{Y}
11:  $numeratorProbMatY ← \frac{1}{( 1 + SquaredEuclidianDistance ( \hat{X} , X ) )}$
12:  $ProbMatY ← \frac{numeratorProbMatY}{\sum ( Flatten ( numeratorProbMatY ) )}$
13: K = numeratorProbMatY ○ (ProbMatX − ProbMatY)
14: σ ← E_{columns}(K)
15: term₁ ← \hat{X} ○ σ
16: term₂ ← K × X
17: Grad₂ ← 4 * (term₁ − term₂)
18: entropy_{X} = Flatten(pⱼⱼ)^{T} × log(Flatten(pⱼⱼ))
19: entropy_{Y} = Flatten(ProbMatY)^{T} × log(Flatten(ProbMatY))
20: KL_{DIV} = entropy_{X} − entropy_{Y}
21: Loss = frac * KL_{DIV} + (1 − frac) * KL′_{DIV}
22: Grad = frac ○ Grad₂ + (1 − frac) * Grad₁
23: return Loss, Grad
24: end function
```

### Example

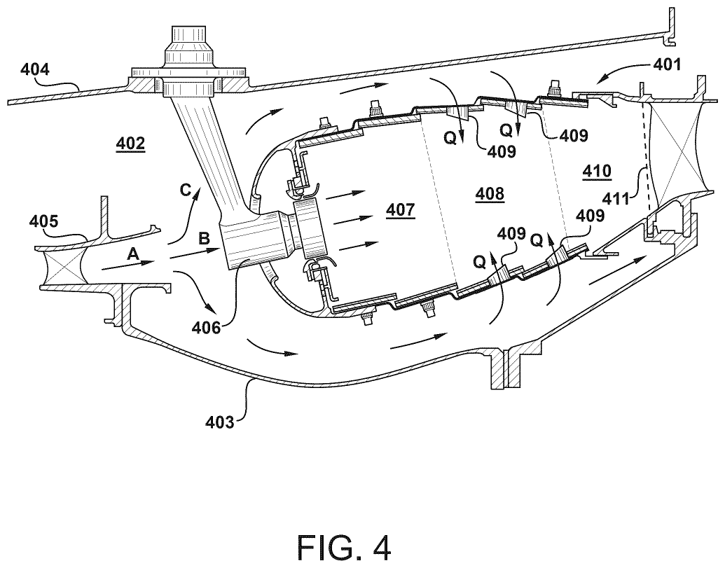

A section through a gas turbine engine combustor is shown in FIG. 4. The combustor 401 is mounted within a cavity 402 formed by an inner air casing 403 and outer air casing 404.

In operation, the high-pressure air A is delivered to the cavity 402 via a diffuser 405. At this point, a quantity of the air enters the combustor 401 as combustion air B through a fuel injector 406 and/or mixing ports at the entrance to the combustor 401 into rich-burn zone 407. In operation, the rich-burn zone 407 has a fuel-rich fuel-air ratio. The remaining air flows around the combustor 401 as cooling air C, a quantity of which is admitted into combustor 401 as quench air Q into the quick-quench zone 408 via a series of quench ports 409. In this example, there are two inner rows and two outer rows of quench ports 409. Amongst other things, this reduces formation of oxides of nitrogen (NOx). It also causes continued combustion to occur under lean conditions in a lean-burn zone 410. The remaining cooling air C may be directed to cool the liner of the combustor 401 and/or as dilution air prior to entering the high-pressure turbine 207, etc.

It will be appreciated that the configuration, for example size, shape, number, location, etc. of quench ports 409 has a strong effect on the quantity EINOx, which is the NOx emissions index. A typical optimisation problem during the design of a gas turbine engine is to minimise EINOx, with simulations and eventually experiments being conducted to evaluate the NOx at the exit plane 411 of the combustor 401.

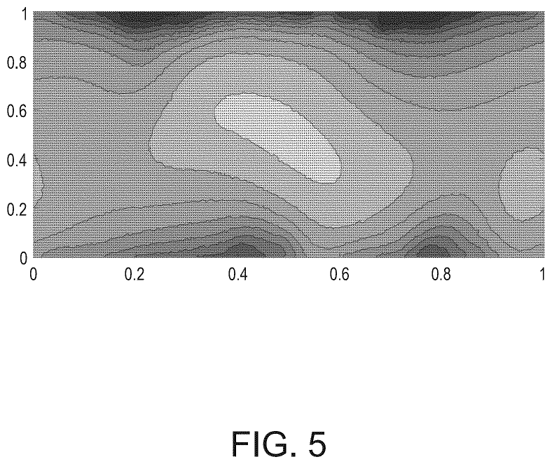

An example of such NOx measurements for a sector of the combustor 401 is shown in FIG. 5, which plots NOx concentration for circumferential (abscissa) and radial (ordinate) directions. In terms of the nomenclature used previously, FIG. 5 shows a member of X which is used in the augmentation process.

In the example, the source data parameterisation consisted of eight design variables are used, four of which describe the axial location of each row of quench ports 409, while the other four define their radius. A set of 100 simulations associated with this source data parameterisation was obtained.

The target data parameterisation consisted of twelve design variables. These consist of the x-y displacements of six control points, which define the centres of radial basis functions that are used to morph the mesh of the inner and outer walls of the combustor 401. A set of 60 simulations associated with this target data parameterisation was also obtained.

Physics measurements were obtained by creating a two-dimensional grid at the exit plane 411. The grid was set up in a 250×100 formation. NOx values were interpolated from the original CFD discretisation at these points. The result of this operation was a dataset Z of shape n×25000, where n is the number of simulations obtained.

Hence, the samples from the source data parameterisation were bounded by a 8-dimensional unit hypercube, [0,1]⁸, and the samples from the target data parameterisation were bounded by a 16-dimensional unit hypercube, [0,1]¹⁶.

In line with common practice in surrogate-based design optimisation, the initial training dataset was updated over the course of ten iterations. This paradigm dictates that the statistical properties of models like Gaussian Process regression can be used to find the most likely combination of design variables that yield a global minimum for the EINOx function dependent variable. At each update, the following acquisition functions were used:

$${min}_{x} \hat{f} ( x ) \qquad [ Function 1 ]$$

$${max}_{x} EI [ \hat{f} ( x ) ] \qquad [ Function 2 ]$$

$${max}_{x} {\hat{s}}^{2} ( x ) \qquad [ Function 3 ]$$

$${max}_{x} {‖ x - \dot{X} ‖}^{2} \qquad [ Function 4 ]$$

Function 1 minimised the constrained regressor, function 2 maximised the unconstrained expected improvement of regressor, function 3 maximised the unconstrained variance of regressor, and function 4 maximised the unconstrained distance to existing training samples. The acquisition functions were optimised using a genetic algorithm, which in the present example was the standard ga function in MATLAB available from MathWorks, Inc. of Natick, Massachusetts, USA.

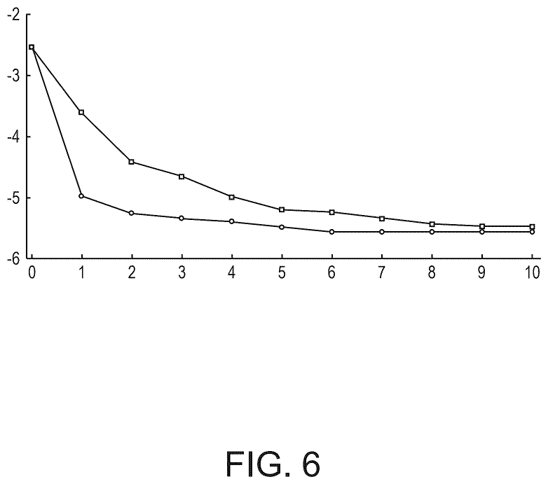

FIG. 6 shows two versions of the update process. The abscissa is the update number and the ordinate is the improvement in EINOx over baseline. The (upper) line with square points is achieved using a traditional approach in which the 60 new samples are used to build a standard Gaussian Process regressor, followed by the update strategy. The (lower) line with circular points uses the new approach. The 100 historical samples augment the initial 60 samples. A Gaussian Process regressor with the Coregionalisation kernel is used with the same update strategy.

1. A computer-implemented method of augmenting design variable data associated with a new parameterisation, comprising:
obtaining a first set of physical quantities sampled from one or more simulations associated with a source parameterisation, the first set of physical quantities defining source points in a physics space;
obtaining a second set of physical quantities sampled from one or more simulations associated with a target parameterisation, the second set of physical quantities defining target points in physics space;
determining a distribution of the source points and the target points in physics space;
obtaining a first set of design variables in terms of the target parameterisation and which correspond with the simulations associated with the target parameterisation, the first set of design variables defining target points in a design variable space; and
generating a second set of design variables in terms of the target parameterisation by evaluating source points in design variable space which exist on or within a boundary of the same hypersurface as the target points in design variable space, and which minimise the difference between the distribution of source points and target points in physics space and the distribution of source points and target points in design variable space.

2. The method of claim 1, in which the first set of physical quantities and the second set of physical quantities are combined to form a physics data structure defining source and target points in a design variable space.

3. The method of claim 2, in which the physics data structure is a matrix of dimension (n+m)×d, where m is a number of sampled simulations associated with a source parameterisation, n is a number of sampled simulations associated with a target parameterisation, and d is a number of physical quantities sampled from each simulation.

4. The method of claim 1, in which determining the distribution of the source and target points in physics space comprises normalising the first set of physical quantities and the second set of physical quantities to have zero mean and unit standard deviation.

5. The method of claim 4, in which determining the distribution of the source and target points in physics space comprises evaluating pairwise similarity over the source points and the target points in physics space, whereby the resulting co-variance is a first probability density function.

6. The method of claim 5, in which evaluation of the pairwise similarity over the source points and the target points in physics space uses a Gaussian kernel function normalised by a softmax function.

7. The method of claim 4, in which determining the distribution of the source and target points in design variable space comprises evaluating pairwise similarity over the source points and the target points in design variable space, whereby the resulting co-variance is a second probability density function.

8. The method of claim 7, in which evaluation of the pairwise similarity over the source points and the target points in design variable space uses a Cauchy distribution.

9. The method of claim 1, in which the second set of design variables are generated using an iterative process.

10. The method of claim 9, in which the iterative process comprises a vectorised gradient calculation that minimises a loss function that expresses differences between the first distribution and the second distribution.

11. The method of claim 7, further comprising repeating one or more of:
evaluating pairwise similarity over the source points and the target points in physics space, and
evaluating pairwise similarity over the source points and the target points in design variable space;
a plurality of times using different parameters to maximise a mean accuracy metric.

12. The method of claim 1, in which the physical quantities sampled from the first set of simulations and the second set of simulations are downsampled according to the same sampling strategy.

13. The method of claim 12, in which the downsampling comprises interpolation between simulation output and a set of fixed points.

14. The method of claim 13, in which the set of fixed points are a constant grid.

15. The method of claim 1, further comprising training a new surrogate model in terms of the target parameterisation using the first set of design variables, the second set of design variables, the first set of physical quantities and the second set of physical quantities.

16. The method of claim 1, in which the target parameterisation is different from the source parameterisation.

17. The method of claim 1, in which the one or more simulations comprise the output of a computational fluid dynamics or a finite element analysis simulation.

18. The method of claim 1, in which the one or more simulations relate to simulation of a gas turbine engine or a gas turbine engine component.

19. A non-transitory computer-readable medium having computer-readable instructions executable by a computer encoded thereon which, when executed, cause the computer to perform a method of augmenting design variable data associated with a new parameterisation, comprising:
obtaining a first set of physical quantities sampled from one or more simulations associated with a source parameterisation, the first set of physical quantities defining source points in a physics space;
obtaining a second set of physical quantities sampled from one or more simulations associated with a target parameterisation, the second set of physical quantities defining target points in physics space;
determining a distribution of the source points and the target points in physics space;
obtaining a first set of design variables in terms of the target parameterisation and which correspond with the simulations associated with the target parameterisation, the first set of design variables defining target points in a design variable space; and
generating a second set of design variables in terms of the target parameterisation by evaluating source points in design variable space which exist on or within a boundary of the same hypersurface as the target points in design variable space, and which minimise the difference between the distribution of source points and target points in physics space and the distribution of source points and target points in design variable space.

20. Apparatus for augmenting design variable data associated with a new parameterisation, comprising memory and a processor configured to:
obtain, from said memory, a first set of physical quantities sampled from one or more simulations associated with a source parameterisation, the first set of physical quantities defining source points in a physics space;
obtain, from said memory, a second set of physical quantities sampled from one or more simulations associated with a target parameterisation, the second set of physical quantities defining target points in physics space;
determine a distribution of the source points and the target points in physics space;
obtain, from said memory, a first set of design variables in terms of the target parameterisation and which correspond with the simulations associated with the target parameterisation, the first set of design variables defining target points in a design variable space; and
generate a second set of design variables in terms of the target parameterisation by evaluating source points in design variable space which exist on or within a boundary of the same hypersurface as the target points in design variable space, and which minimise the difference between the distribution of source points and target points in physics space and the distribution of source points and target points in design variable space.
